(19) United States
(12) Patent Application Publication
(10) Pub. No.: US 2026/0124950 A1
(43) Pub. Date: May 7, 2026

(54) CHARGE AND DISCHARGE MANAGEMENT SYSTEM

(71) Applicant: TOYOTA JIDOSHA KABUSHIKI KAISHA, Toyota-shi (JP)

(72) Inventor: Yuya YAMAUCHI, Nagoya-shi (JP)

(73) Assignee: TOYOTA JIDOSHA KABUSHIKI KAISHA, Toyota-shi (JP)

(21) Appl. No.: 19/281,947

(22) Filed: Jul. 28, 2025

(30) Foreign Application Priority Data
Nov. 7, 2024 (JP) 2024-195164

(51) Int. Cl. B60L 53/67; B60L 53/62; B60L 53/63; B60L 53/66; B60L 55/00

(52) U.S. Cl. CPC B60L 53/67; B60L 53/62; B60L 53/63; B60L 53/66; B60L 55/00

(57) ABSTRACT

The charge and discharge management system compares the transmission-command number scheduled to be transmitted at each time with the upper-limit transmission number, and when determination is made that the transmission-command number is equal to or less than the upper-limit transmission number, the charge and discharge management system keeps the scheduled transmission time according to the plan, and when determination is made that the transmission-command number is more than the upper-limit transmission number, the charge and discharge management system adjusts the transmission time of the command such that the transmission time of the command having a low command priority is shifted from the time scheduled in the plan to the earlier time or later time than the time by using the command priority information.

### CROSS-REFERENCE TO RELATED APPLICATION

This application claims priority to Japanese Patent Application No. 2024-195164 filed on Nov. 7, 2024. The disclosure of the above-identified application, including the specification, drawings, and claims, is incorporated by reference herein in its entirety.

### BACKGROUND

### 1. Technical Field

The present disclosure relates to a charge and discharge management system.

### 2. Description of Related Art

Japanese Unexamined Patent Application Publication No. 2023-169556 (JP 2023-169556 A) discloses a management device that performs power management of a microgrid using a plurality of power resources (such as stationary storage batteries or battery electric vehicles). The management device is configured to store information. The information is information in which a battery electric vehicle in which power reception is interrupted during execution of a power reception plan for the microgrid is associated with a time when the power reception is interrupted, among battery electric vehicles selected as the power resource. The management device specifies the battery electric vehicle that has experienced a power receiving interruption at a time included in an execution period of a new power reception plan based on the stored information. The management device excludes the specified battery electric vehicle from the power resource. In this way, battery electric vehicles that can respond to a virtual power plant (VPP) are selected based on past results.

### SUMMARY

In JP 2023-169556 A, determination is made as to whether desired charge and discharge control is possible for a power resource, but there is no mention of whether an instruction command can be transmitted to the power resource at an appropriate timing. In a case of large-scale power control such as VPP, command transmission times for a plurality of power resources configuring a microgrid may be duplicated. When the command transmission times are duplicated, a processing delay may occur, and the commands may not be transmitted at the planned time. As a result, there is a concern that appropriate power control to meet a request from a power market or the like cannot be realized.

Hereinafter, methods for solving the above issue and effects thereof will be described. A charge and discharge management system for solving the issue includes a processing circuit and a storage device. In the charge and discharge management system, the processing circuit is configured to compare a transmission-command number that is the number of commands scheduled to be transmitted to the multiple battery electric vehicles at each time based on a plan generated for each of the multiple battery electric vehicles with an upper-limit transmission number that is the number of commands transmittable at the same time without causing a processing delay, and determine whether the transmission-command number is equal to or less than the upper-limit transmission number. In the charge and discharge management system, the processing circuit is configured to, when the transmission-command number is determined to be equal to or less than the upper-limit transmission number, maintain a transmission time according to the plan, and when the transmission-command number is determined to be larger than the upper-limit transmission number, adjust the transmission time of a command having a low command priority such that, the transmission time of the command having the low command priority is shifted to an earlier time or a later time than a time scheduled in the plan by using command priority information stored in the storage device in advance. In the charge and discharge management system, the processing circuit is configured to transmit the commands corresponding to each of the multiple battery electric vehicles according to the adjusted plan.

With the charge and discharge management system, it is possible to suppress a processing delay caused by the duplication of the transmission times of the commands.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing each functional unit configuring a charge and discharge management system according to a first embodiment;

FIG. 2 is a diagram showing a configuration of a schedule adjuster provided in the charge and discharge management system of FIG. 1;

FIG. 3 is an example of a timing chart for describing an energy management plan generated for one battery electric vehicle;

FIG. 4A is a table showing an energy management plan generated for a plurality of battery electric vehicles, and shows an energy management plan for each battery electric vehicle;

FIG. 4B shows the command transmission request at each time;

FIG. 5 is a flowchart for describing a flow of a process of deciding a time for transmitting a command to each of the battery electric vehicles in the charge and discharge management system of FIG. 1;

FIG. 6A is a diagram for describing that the transmission time of the command is adjusted by using the content of the event in the charging management system of FIG. 1, and shows the command transmission request at each time before adjustment;

FIG. 6B is a diagram for describing a case where the transmission time of the command is adjusted by using the content of the event in the charging management system of FIG. 1, and shows a case where the command of the “end” event of the battery electric vehicle H is added at a time of 19:00;

FIG. 6C is a diagram for describing a case where the transmission time of the command is adjusted by using the content of the event in the charging management system of FIG. 1, and shows a case where the command of the “start” event of the battery electric vehicle H is added at the time of 19:00;

FIG. 6D is a diagram for describing a case where the command of the “stop” event of the battery electric vehicle H is added at the time of 19:00 in the charging management system of FIG. 1, and the transmission time of the command is adjusted by using the content of the event;

FIG. 7A is a diagram for describing a second embodiment in which a transmission time of a command is adjusted using a needed charge amount, and shows a command transmission request at each time before adjustment;

FIG. 7B is a diagram for describing a second embodiment in which the transmission time of the command is adjusted by using the needed charge amount, and shows a case where the command of the “start” event of the battery electric vehicle H is added at the time of 19:00;

FIG. 7C is a diagram for describing a second embodiment in which the transmission time of the command is adjusted by using the needed charge amount, and shows a case where the command of the “stop” event of the battery electric vehicle H is added at the time of 19:00;

FIG. 8A is a diagram for describing a third embodiment in which a transmission time of a command is adjusted by using the number of times the transmission time of the command is adjusted, and shows a command transmission request at each time before adjustment;

FIG. 8B is a diagram for describing a third embodiment in which the transmission time of the command is adjusted by using the number of times the transmission time of the command is adjusted, and shows a case where the command of the “start” event of the battery electric vehicle H is added at the time of 19:00; and

FIG. 8C is a diagram for describing a third embodiment in which the transmission time of the command is adjusted by using the number of times the transmission time of the command is adjusted, and shows a case where the command of the “stop” event of the battery electric vehicle H is added at the time of 19:00.

### DETAILED DESCRIPTION OF EMBODIMENTS

### First Embodiment

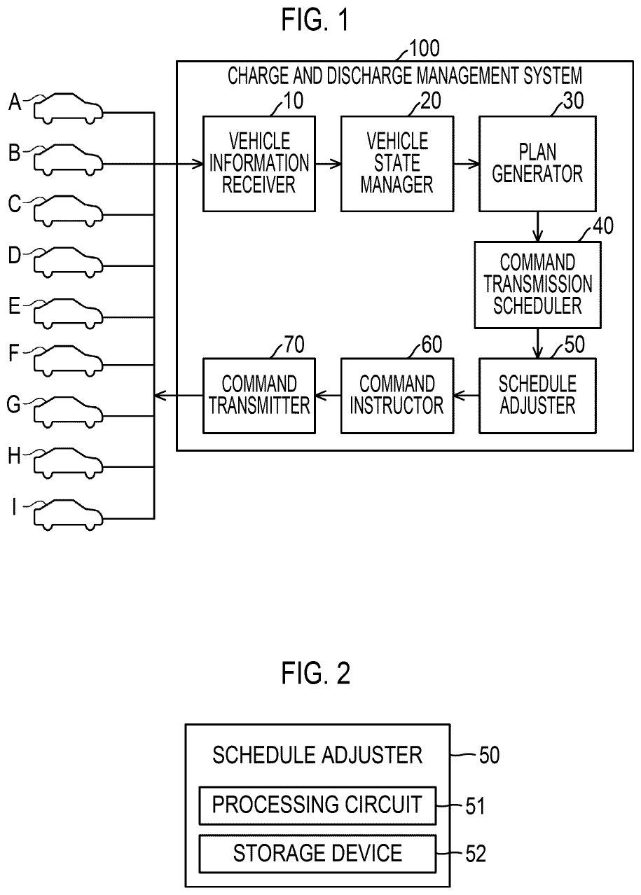

The first embodiment of the charge and discharge management system 100 will be described below with reference to FIGS. 1 to 6D. FIG. 1 shows a charge and discharge management system 100 that can perform bidirectional wireless communication with a plurality of battery electric vehicles A to I. The battery electric vehicles A to I are vehicles that can store power in the battery and can also supply the stored power to an external power network, a home, or other devices.

### Regarding Each Functional Unit of Charge and Discharge Management System 100

As shown in FIG. 1, the charge and discharge management system 100 includes a vehicle information receiver 10, a vehicle state manager 20, a plan generator 30, and a command transmission scheduler 40. The charge and discharge management system 100 includes a schedule adjuster 50, a command instructor 60, and a command transmitter 70. Inside the charge and discharge management system 100, the vehicle information receiver 10 processes the information in the order of the vehicle state manager 20, the plan 10 generator 30, the command transmission scheduler 40, the schedule adjuster 50, the command instructor 60, and the command transmitter 70. Then, the command is transmitted from the command transmitter 70 to the corresponding battery electric vehicles A to I. Each unit of the charge and discharge management system 100 can be implemented by one or a plurality of processing circuits. Examples of the processing circuit include an application specific integrated circuit (ASIC) or a field programmable gate array (FPGA) designed to execute various functions. In addition, the processing circuit may be a processing circuit as dedicated hardware or a processor that executes a program stored in a memory.

The vehicle information receiver 10 receives vehicle information on the vehicle state of each of the battery electric vehicles A to I. The vehicle information is information regarding a charging and discharging situation of a battery electric vehicle. Examples of the vehicle information include a remaining capacity of an SOC indicating a current remaining capacity of a vehicle battery, a target SOC indicating a value of an SOC to be aimed at for the vehicle battery to exhibit appropriate performance, a departure time set by the user, and a DR participation intention. The intention to participate in the DR is an intention indication of the user indicating that the user accepts the charge and discharge control for responding to the demand response request.

The vehicle state manager 20 uses the vehicle information of the battery electric vehicles A to I received by the vehicle information receiver 10 to integrally manage the vehicle state of each of the battery electric vehicles A to I. The vehicle state manager 20 can grasp the charging status of the battery electric vehicles A to I in real time.

The plan generator 30 uses the vehicle information of the battery electric vehicles A to I to generate the energy management plan for each of the battery electric vehicles A to I. The vehicle information of the battery electric vehicles A to I is managed by the vehicle state manager 20. For example, the plan generator 30 considers the efficient use of energy. The plan generator 30 generates a plan for charging and discharging each of the battery electric vehicles A to I to start and stop charging a plurality of times in order to adjust the load on the overall power supply. As a result, it is possible to, for example, shift a peak of power demand or maximize the use of renewable energy. The plan generator 30 generates a command for executing the start, stop, end, or the like of charging and discharging for each of the battery electric vehicles A to I based on the generated plan for charging and discharging.

The command transmission scheduler 40 manages the timing or order of transmitting the command for each of the battery electric vehicles A to I to charge and discharge the battery of each of the battery electric vehicles A to I based on the energy management plan. The energy management plan is a plan generated by the plan generator 30. Specifically, the command transmission scheduler 40 schedules which command is transmitted at what time, that is, the transmission time of each command.

When the number of commands scheduled to be transmitted at the same time is larger than a predetermined value, the schedule adjuster 50 adjusts the transmission time of the command decided by the command transmission scheduler 40.

As shown in FIG. 2, the schedule adjuster 50 includes a processing circuit 51 and a storage device 52. The processing circuit 51 adjusts the transmission time of the command decided by the command transmission scheduler 40. The storage device 52 stores a transmission time of the adjusted command, an upper-limit transmission number, command priority information, and the like. The upper-limit transmission number and the command priority information will be described below. The schedule adjuster 50 suppresses the number of commands scheduled to be transmitted at the same time to a value equal to or less than a predetermined value.

The command instructor 60 instructs the command transmission at the timing when the transmission time of the command decided by the command transmission scheduler 40 or the transmission time of the command adjusted by the schedule adjuster 50 arrives. In a case where the command transmission is instructed by the command instructor 60, the command transmitter 70 transmits the command to the battery electric vehicle to which the command corresponds.

The charge and discharge management system 100 transmits the command to each of the battery electric vehicles A to I, and charges and discharges the battery electric vehicles A to I in response to the command received by each of the battery electric vehicles A to I.

### Plan Generator 30

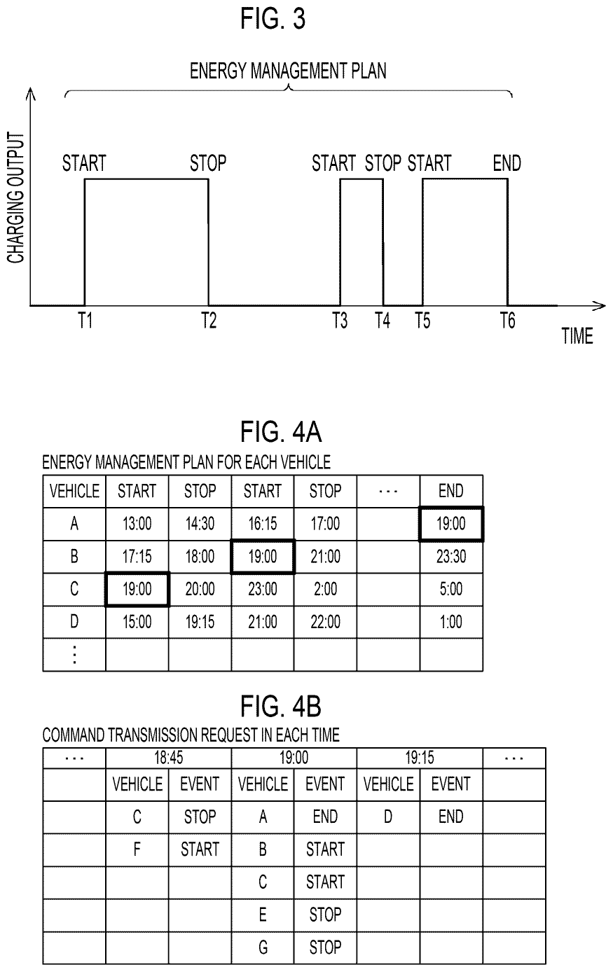

FIG. 3 is an example of a timing chart showing an energy management plan for one battery electric vehicle generated by the plan generator 30. In FIG. 3, a vertical axis represents a charging output, and a horizontal axis represents a time, respectively. Here, one battery electric vehicle is, for example, the battery electric vehicle A. Although FIG. 3 shows a timing chart of charging, the same energy management plan is applied in a case of discharging. In the case of the discharge, the vertical axis corresponding to the charging output represents the discharging output.

The plan generator 30 considers the efficient use of energy. The plan generator 30 calculates an energy management plan for starting and stopping charging of the battery electric vehicle A based on the vehicle information of the battery electric vehicle A managed by the vehicle state manager 20. Specifically, in the energy management plan shown in FIG. 3, the battery electric vehicle A first starts charging at time T1 and then stops charging at time T2. Next, the battery electric vehicle A starts charging again at time T3 and stops again at time T4. Then, the battery electric vehicle A starts charging at time T5, and charging ends at time T6.

The plan generator 30 generates a command for executing the start, stop, and end of charging corresponding to each of times T1 to T6 in the battery electric vehicle A based on the calculated energy management plan. That is, the plan generator 30 generates three “charge start” commands for starting the charging of the battery electric vehicle A at the times T1, T3, T5. The plan generator 30 generates two “charge stop” commands for temporarily stopping the charging of the battery electric vehicle A at the times T2 and T4. The plan generator 30 generates one “charge end” command for ending the charging of the battery electric vehicle A at time T6. The commands are scheduled to be transmitted to the battery electric vehicle A at each of times T1 to T6.

As described above, the plan generator 30 calculates the energy management plan of the battery electric vehicle A and generates the command to be transmitted to the battery electric vehicle A. In addition, the plan generator 30 calculates the energy management plan for the battery electric vehicles B to I in the same manner as the battery electric vehicle A, and generates the command to be transmitted.

### Command Transmission Scheduler 40

Hereinafter, scheduling of the transmission timing of the command to be transmitted to each of the battery electric vehicles A to I will be described. FIGS. 4A and 4B are tables showing commands transmitted from the plan generator 30 to each of the battery electric vehicles A to I. FIG. 4A shows, as an example, a command to be transmitted and a transmission time corresponding to each command for each of battery electric vehicles A to D. As shown in FIG. 4A, rows correspond to each of battery electric vehicles A to D, and columns represent stages of the charging/discharging process. In a case of a first row, there is the start of charging at the time of 13:00 as the command transmission request for the battery electric vehicle A. Further, in a case of the A row, there is a stop of charging at the time of 14:30, a start of charging at the time of 16:15, and a stop of charging at the time of 17:00 for the battery electric vehicle A. Further, in a case of the A row, the end of charging at the time of 19:00 is present for the battery electric vehicle A. At each time, a command of “start”, “stop”, or “end” of the discharge may also be scheduled.

In FIG. 4A, as in the portion surrounded by a thick line, at the time of 19:00, the “end” command of the battery electric vehicle A is present. Further, at the time of 19:00, a “start” command of the battery electric vehicle B and a “start” command of the battery electric vehicle C are present.

FIG. 4B shows an example of the command transmission request at each time. As described above, a plurality of command transmission requests may be scheduled for the same time. In the example shown in FIG. 4B, the command transmission scheduler 40 schedules the command for stopping the battery electric vehicle C at the time of 18:45. Further, the command transmission scheduler 40 schedules the start command in the battery electric vehicle F at the time of 18:45. The command transmission scheduler 40 schedules the end command in the battery electric vehicle A and the start command in the battery electric vehicle B at the time of 19:00. The command transmission scheduler 40 schedules the start command in the battery electric vehicle C and the stop command in the battery electric vehicle E at the time of 19:00. The command transmission scheduler 40 schedules the command for stopping the battery electric vehicle E at the time of 19:00. Further, the command transmission scheduler 40 schedules the command for stopping the battery electric vehicle D at the time of 19:15.

As described above, the command transmission scheduler 40 arranges a plurality of transmission commands for the battery electric vehicles A to I for each time, and schedules the transmission commands.

Flow of Process of Deciding Time to Transmit Command by Charge and Discharge Management System 100

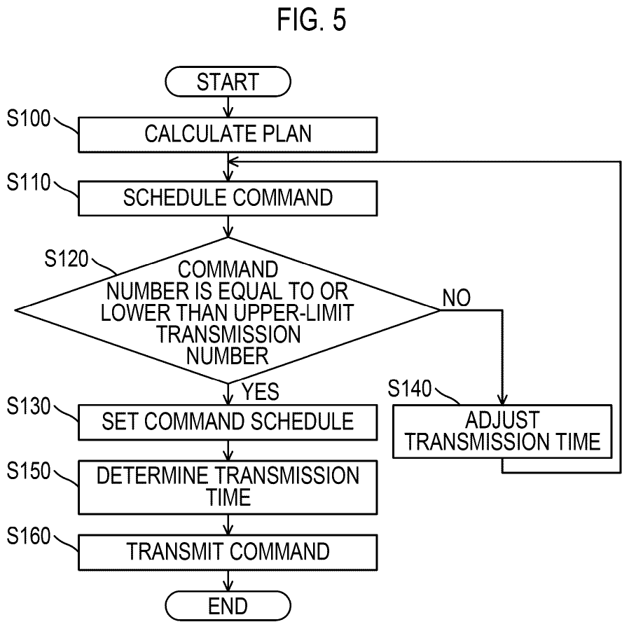

Next, a flow of a process of deciding a time at which the charge and discharge management system 100 transmits the command to each of the battery electric vehicles A to I will be described with reference to FIG. 5. For example, the charge and discharge management system 100 confirms that all of the following are established: the DR request is made, the battery electric vehicle is connected to the charging plug, and the user has the intention to participate in the DR. The controller executes the series of processes described above. The DR request is a request for balancing the demand and supply of the power.

First, in S100, the charge and discharge management system 100 calculates the energy management plan as shown in FIG. 3 for each of the battery electric vehicles A to I by the plan generator 30. The charge and discharge management system 100 generates a command scheduled to be transmitted to each of the battery electric vehicles A to I by the plan generator 30.

Next, the charge and discharge management system 100 progresses the process to S110. In S110, the charge and discharge management system 100 schedules the transmission command for the battery electric vehicles A to I at each transmission time by the command transmission scheduler 40. The charge and discharge management system 100 schedules the transmission command for each transmission time by the command transmission scheduler 40, as in the example described with reference to FIGS. 4A and 4B.

Then, the charge and discharge management system 100 progresses the process to S120. In S120, the charge and discharge management system 100 compares the transmission-command number with the upper-limit transmission number stored in the storage device 52 for the battery electric vehicles A to I by the processing circuit 51 of the schedule adjuster 50. The transmission-command number is the number of commands scheduled to be transmitted at each time. The charge and discharge management system 100 determines whether the transmission-command number is equal to or less than the upper-limit transmission number by the processing circuit 51 of the schedule adjuster 50. The upper-limit transmission number is the number of commands that can be transmitted by the charge and discharge management system 100 such that the processing delay does not occur at the same time. The upper-limit transmission number is set after considering the constraint of the resource, the load management of the charging and discharging process, the I/O bandwidth, the communication infrastructure, and the like, and is stored in the storage device 52 in advance.

In S120, the processing circuit 51 progresses the processing to S130 in a case where the transmission-command number is determined to be equal to or less than the upper-limit transmission number (S120: YES). The processing circuit 51 sets the command schedule such that the transmission time of the command scheduled in S110 is maintained in S130.

On the other hand, in S120, the processing circuit 51 progresses the processing to S140 in a case where the processing circuit 51 determines that the transmission-command number is larger than the upper-limit transmission number (S120: NO). In S140, the processing circuit 51 adjusts the transmission time of the command having the low command priority to such that the transmission time is shifted to an earlier time or later time than the scheduled time in S110 by using the command priority information stored in the storage device 52 in advance. The charge and discharge management system 100 returns the transmission time of the adjusted command to S110 in S140, and reschedules the command. As described above, in a case where the transmission-command number is larger than the upper-limit transmission number, the processing of S110, S120, and S140 is repeated, so that the transmission-command number is finally suppressed to be equal to or less than the upper-limit transmission number.

As described above, the charge and discharge management system 100 proceeds with the process to S130 by using the command in which the transmission-command number is suppressed to be equal to or less than the upper-limit transmission number, and sets the command schedule in S130.

Further, the charge and discharge management system 100 progresses the process to S150, and determines whether the transmission time of each command has arrived based on the command schedule set in S130. In a case where the determination is made in S150 that the transmission time of each command has arrived, the charge and discharge management system 100 proceeds to S160, and executes the transmission of the command set at the transmission time. In this way, the series of processes is temporarily ended.

### Example of Processing by Processing Circuit 51

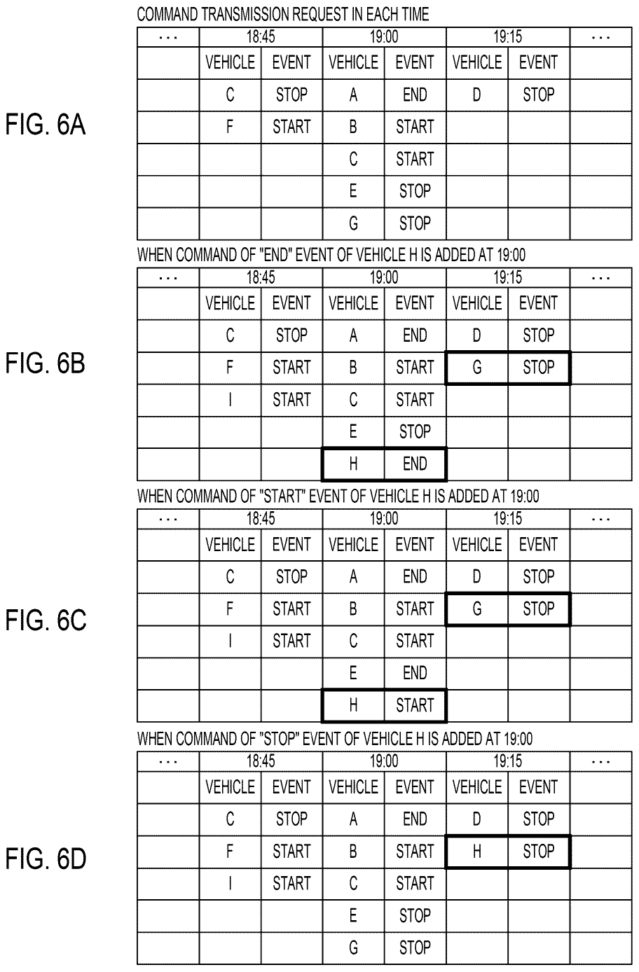

Processing by the processing circuit 51 will be described with reference to FIGS. 6A to 6D. In the example shown in FIGS. 6A to 6D, the content of the event corresponding to the command is used as the command priority information. The content of the event includes an end indicating that the charging or discharging is ended, a start indicating that the charging or discharging is started, and a stop indicating that the charging and discharging is temporarily stopped during the charging or discharging. The command priority depending on the content of the event is set to be lower in the order of end, start, and stop. The upper-limit transmission number, which is the number of commands that can be transmitted such that the processing delay does not occur in the charge and discharge management system 100 at the same time, is set to, for example, five.

FIG. 6A shows the command transmission request at each time, and commands transmitted at each time are scheduled for each column for each of a plurality of battery electric vehicles A to G. In the example shown in FIG. 6A, at the time of 18:45, a command of the “stop” event of the battery electric vehicle C and a command of the “start” event of the battery electric vehicle F are present. Even when the command of the “start” event of the battery electric vehicle I is added at the time of 18:45, the number of commands transmitted at this time is three, which is five or less, which is the upper-limit transmission number (S120: YES). Therefore, the command of the “start” event of the battery electric vehicle I is simply added at the time of 18:45 (see FIGS. 6B to 6D).

On the other hand, at the time of 19:00, the command of the “end” event of the battery electric vehicle A and the command of the “start” event of the battery electric vehicle B and the battery electric vehicle C are present. At a time of 19:00, the command of the “stop” event of the battery electric vehicle E and the battery electric vehicle G is present. Therefore, at the time of 19:00, the number of commands to be transmitted reaches five, which is the upper-limit transmission number. In this case, assuming that the command of the battery electric vehicle H is added at the time of 19:00, the transmission-command number is larger than the upper-limit transmission number (S120: NO). In a case where the situation is as described above, the processing circuit 51 compares the priorities of each of the commands.

FIG. 6B shows a case where the command of the “end” event of the battery electric vehicle H is added at the time of 19:00. The processing circuit 51 can determine that the priority of the command of the “stop” event of the battery electric vehicle G is the lowest by comparing the priorities of each of the commands at the time of 19:00. In this case, the processing circuit 51 simply adds the command of the “end” event of the battery electric vehicle H at the time of 19:00. Further, the processing circuit 51 shifts the command of the “stop” event of the battery electric vehicle G to the later time, that is, the time of 19:15.

FIG. 6C shows a case where the command of the “start” event of the battery electric vehicle H is added at the time of 19:00. The processing circuit 51 can determine that the priority of the command of the “stop” event of the battery electric vehicle G is the lowest by comparing the priorities of each of the commands at the time of 19:00. In this case, the processing circuit 51 simply adds the command of the “start” event of the battery electric vehicle H at the time of 19:00. Further, the processing circuit 51 shifts the command of the “stop” event of the battery electric vehicle G to the later time, that is, the time of 19:15.

FIG. 6D shows a case where the command of the “stop” event of the battery electric vehicle H is added at the time of 19:00. The processing circuit 51 can determine that the priority of the command of the “stop” event of the battery electric vehicle H is the lowest by comparing the priorities of each of the commands at the time of 19:00. In this case, the processing circuit 51 adds the command of the “stop” event of the battery electric vehicle H not at the time of 19:00, but at a later time, that is, at the time of 19:15. When there are a plurality of commands on the same event at the same time, the processing circuit 51 determines that the command added later has the lowest priority among the commands on the same event at the same time.

As described above, by adjusting the transmission time of the command having the low command priority such that the transmission time is shifted to a time later than the scheduled time of 19:00, the number of commands to be transmitted at the time of 19:00 can be suppressed to five or less, which is the upper-limit transmission number.

### Operation of Present Embodiment

The charge and discharge management system 100 includes the processing circuit 51 and the storage device 52. The processing circuit 51 compares the transmission-command number for the battery electric vehicles A to I with the upper-limit transmission number of commands that can be transmitted such that the processing delay does not occur at the same time for the battery electric vehicles A to I based on the generated plan for each of the battery electric vehicles A to I. The transmission-command number is the number of commands scheduled to be transmitted at each time. The processing circuit 51 determines whether the transmission-command number is equal to or less than the upper-limit transmission number. When the processing circuit 51 determines that the transmission-command number is equal to or less than the upper-limit transmission number, the processing circuit 51 keeps the transmission time according to the plan. On the other hand, when the processing circuit 51 determines that the transmission-command number is greater than the upper-limit transmission number, the processing circuit 51 adjusts the transmission time of the command as follows. The processing circuit 51 adjusts the transmission time of the command such that the transmission time of the command is shifted from the scheduled time in the plan to the earlier time or later time than the scheduled time, by using the command priority information, in a case where the command priority is low. The command priority information is stored in the storage device 52 in advance. The processing circuit 51 transmits the command corresponding to each of the battery electric vehicles A to I in accordance with the adjusted plan.

As described above, the charge and discharge management system 100 adjusts the transmission-command number to be transmitted at the same time to be equal to or less than the upper-limit transmission number of commands that can be transmitted without a processing delay occurring, in accordance with the priority.

### Effect of Present Embodiment

(1) The charge and discharge management system 100 can suppress a processing delay caused by duplication of the transmission time of the command. The charge and discharge management system 100 can perform flexible command management in response to the priority. Therefore, the charge and discharge management system 100 preferentially transmits significant instructions regarding the charge and discharge of the battery electric vehicles A to I, and adjusts the instructions that can be postponed without any problem. As a result, the entire charge and discharge process can be smoothly executed. As a result, it is possible to realize appropriate power control in response to a request from a power market or the like.
(2) The command priority information includes the content of the event for causing the command to be executed from the battery electric vehicles A to I. The content of the event includes an end indicating that the charging or discharging is ended, a start indicating that the charging or discharging is started, and a stop indicating that the control of the charging and discharging is temporarily stopped during the charging or discharging. The command priority depending on the content of the event is set to be lower in the order of end, start, and stop.

The battery electric vehicle user may set the end time of charging. When the charging end time is set by the user, the “end” event is advantageously set to the charging end time set by the user. In the charge and discharge management system 100, the “end” event is given the highest priority, and the “start” event is processed with a higher priority than the “stop” event.

As described above, the charge and discharge management system 100 can execute the significant event without delaying the significant event by flexibly adjusting the event having the low command priority. Therefore, the stability of the power supply and the accuracy of the charge and discharge plan can be ensured. In addition, the user can obtain a sense of security that the battery electric vehicle can be operated as planned since the user can surely keep the “end” that is the condition set by the user.

### Second Embodiment

Next, the second embodiment will be described focusing on the differences from the first embodiment. In the first embodiment, the content of the event corresponding to the command was used as the command priority information. In addition, in the second embodiment, the needed charge amount to reach the target charge state set in each of a plurality of battery electric vehicles is used as the command priority information.

The storage device 52 further stores a needed charge amount until the target charge state is set in each of the battery electric vehicles A to I as the command priority information. The needed charge amount is set to be higher as the command priority is higher than the content of the event, and is set to be higher as the needed charge amount is smaller. The needed charge amount can be determined based on the remaining capacity of the SOC of each of the battery electric vehicles A to I acquired by the vehicle information receiver 10 and the target SOC.

### Execution of Processing by Processing Circuit 51

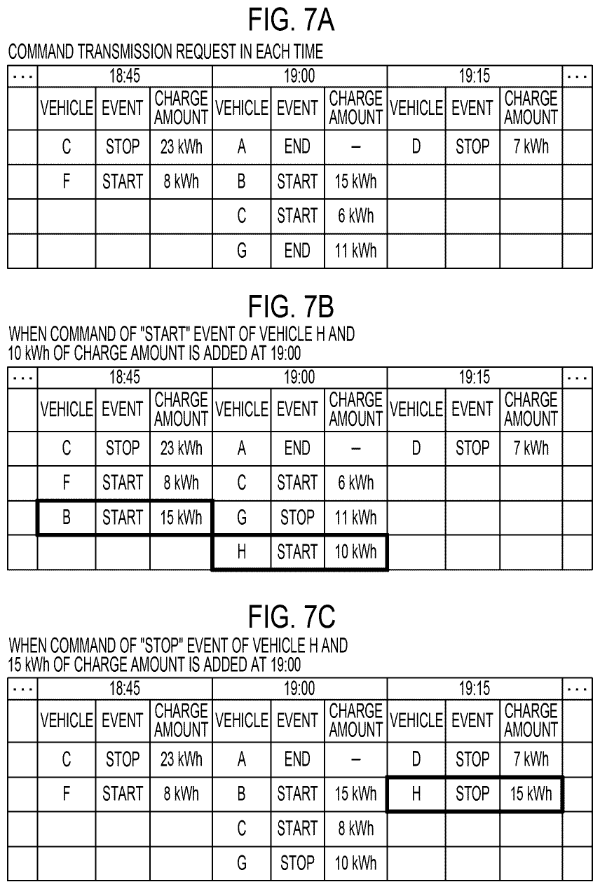

The execution of the processing by the processing circuit 51 of the second embodiment will be described with reference to FIGS. 7A to 7C. In the example shown in FIGS. 7A to 7C, the upper-limit transmission number, which is the number of commands that can be transmitted such that the processing delay does not occur at the same time in the charge and discharge management system 100, is set to, for example, four.

FIG. 7A shows the command transmission request at each time, and commands transmitted at each time are scheduled in each column for each of the battery electric vehicles A to G. In the example shown in FIG. 7A, at the time of 19:00, there is a command of the “end” event of the battery electric vehicle A and a command of the “start” event of the battery electric vehicle B, which is the needed charge amount of 15 kWh. Further, at the time of 19:00, there is a command of the “start” event of the battery electric vehicle C and the needed charge amount is 6 kWh, and a command of the “stop” event of the battery electric vehicle G and the needed charge amount is 11 kWh. Therefore, at the time of 19:00, the number of commands to be transmitted reaches four, which is the upper-limit transmission number. In this case, assuming that the command of the battery electric vehicle H is added at the time of 19:00, the transmission-command number is larger than the upper-limit transmission number (S120: NO). In a case where the situation occurs, the processing circuit 51 compares the needed charge amount of each of the battery electric vehicles A, B, C, G, H as the priority of each command.

FIG. 7B shows a case where a command of the battery electric vehicle H of the “start” event at the time of 19:00 and the needed charge amount of 10 kWh is added. The processing circuit 51 compares the needed charge amount of each of the battery electric vehicles A, B, C, G, H at the time of 19:00. Then, the processing circuit 51 determines that the priority of the command of the battery electric vehicle B is the lowest, since the needed charge amount of the battery electric vehicle B is 15 kWh, which is the highest. In this case, the processing circuit 51 adds a command of the “start” event of the battery electric vehicle H and the needed charge amount of 10 kWh directly at the time of 19:00. The processing circuit 51 adjusts the command to shift the needed charge amount of 15 kWh in the “start” event of the battery electric vehicle B. Since the content of the command of the battery electric vehicle B is “start”, the processing circuit 51 adjusts the command of the battery electric vehicle B to be shifted to the earlier time, that is, the time of 18:45. In this way, by advancing the “start” event, the needed charging can be started early.

FIG. 7C shows a case where a command of the needed charge amount of 15 kWh is added in the “stop” event of the battery electric vehicle H at the time of 19:00. The processing circuit 51 compares the needed charge amount of each of the battery electric vehicles A, B, C, G, H at the time of 19:00. As a result, the processing circuit 51 can determine that the needed charge amount of the battery electric vehicle H is the same as the needed charge amount of the battery electric vehicle B, which is 15 kWh. The processing circuit 51 can determine that the needed charge amount of the battery electric vehicle H is smaller than 6 kWh, which is the needed charge amount of the battery electric vehicle C, and 11 kWh, which is the needed charge amount of the battery electric vehicle G. That is, the processing circuit 51 can determine that the priority of the command of the battery electric vehicle H is the same as the priority of the command of the battery electric vehicle B. The processing circuit 51 can determine that the priority of the command of the battery electric vehicle H is lower than the priority of the command of the battery electric vehicle C and the battery electric vehicle G. In this case, the processing circuit 51 keeps transmitting the command to the battery electric vehicle C and the battery electric vehicle G at the scheduled time of 19:00. Further, the processing circuit 51 shifts any one of the command of the battery electric vehicle H and the command of the battery electric vehicle B from the time of 19:00. The processing circuit 51 determines which transmission time of which command is shifted in the content of the event for the command of the battery electric vehicle H and the command of the battery electric vehicle B. The content of the event of the command of the battery electric vehicle H is stop, and the content of the event of the command of the battery electric vehicle B is start. Therefore, the processing circuit 51 decides to shift the command of the battery electric vehicle H from the time of 19:00. The processing circuit 51 shifts the transmission time of the command from the scheduled time in the plan to the earlier time when the content of the event of the shifting command is the start. The processing circuit 51 adjusts the transmission time of the command such that the transmission time of the command is shifted to a later time than the scheduled time in the plan when the content of the event of the shifting command is stop. In the example shown in FIG. 7C, the command of the battery electric vehicle H that is the “stop” event and the needed charge amount is 15 kWh is adjusted to be shifted from the time of 19:00 to the later time, that is, 19:15.

### Operation of Second Embodiment

The charge and discharge management system 100 uses the needed charge amount until the target charge state is set in each of the battery electric vehicles A, B, C, G, H as the command priority information. The needed charge amount is set to be higher as the command priority is higher than the content of the event, and is set to be higher as the needed charge amount is smaller.

As described above, in the charge and discharge management system 100, the needed charge amount for each of the battery electric vehicles A, B, C, G, H is managed as the command priority information, and the adjustment is made by giving priority to the needed charge amount over the content of the event.

### Effect of Second Embodiment

(1) The charge and discharge management system 100 does not change the plan of the battery electric vehicles C, G that are easily charged to the target charge state. As a result, it is possible to increase the number of battery electric vehicles that can achieve the target charge state.
(2) The charge and discharge management system 100 determines which of the transmission times of the commands is to be shifted in the event content in adjusting the transmission time of the commands between the battery electric vehicles having the same level of the needed charge amount. When the content of the event of the command to be shifted is the start, the charge and discharge management system 100 shifts the transmission time of the command to an earlier time than the scheduled time in the plan. When the content of the event of the command that shifts is stop, the charge and discharge management system 100 adjusts the transmission time of the command such that the transmission time of the command is shifted to a later time than the scheduled time in the plan.

In the charge and discharge management system 100, when the priority is not determined from the needed charge amount, the priority is determined based on the content of the event. When the content of the event of the shifting command is the start, the command is transmitted in advance, and the event is started at an earlier time. On the other hand, in a case where the content of the event of the shifting command is stop, the charge and discharge management system 100 shifts the command corresponding to the event to a later time, and delays the stop timing of the event.

As a result, the charge and discharge management system 100 can efficiently manage the charge amount of the battery electric vehicle B by bringing forward the “start” event to start the needed charge early. On the other hand, the charge and discharge management system 100 shifts the “stop” event having the lowest priority among the events to the rear. As a result, the charge and discharge management system 100 can extend the time for which the charging or discharging is continued and adjust such that the charging process with the higher priority of the other battery electric vehicles A, B, C, G is not affected. As a result, it is possible to maintain the balance of the energy supply of the entire system, to improve the operating efficiency of the entire system while the processing delay is suppressed.

### Third Embodiment

Next, the third embodiment will be described focusing on the differences from the first embodiment. In the first embodiment, the content of the event corresponding to the command was used as the command priority information. In addition, in the third embodiment, an adjustment number representing the number of times of adjustment of the transmission time of the command is used for each command based on the command priority information.

In the third embodiment, the storage device 52 further stores the adjustment number representing the number of times of adjustment of the transmission time of the command based on the command priority information for each command, as the command priority information. The adjustment number is set to be higher than the content of the event, and the higher the adjustment number, the higher the command priority level.

### Execution of Processing by Processing Circuit 51

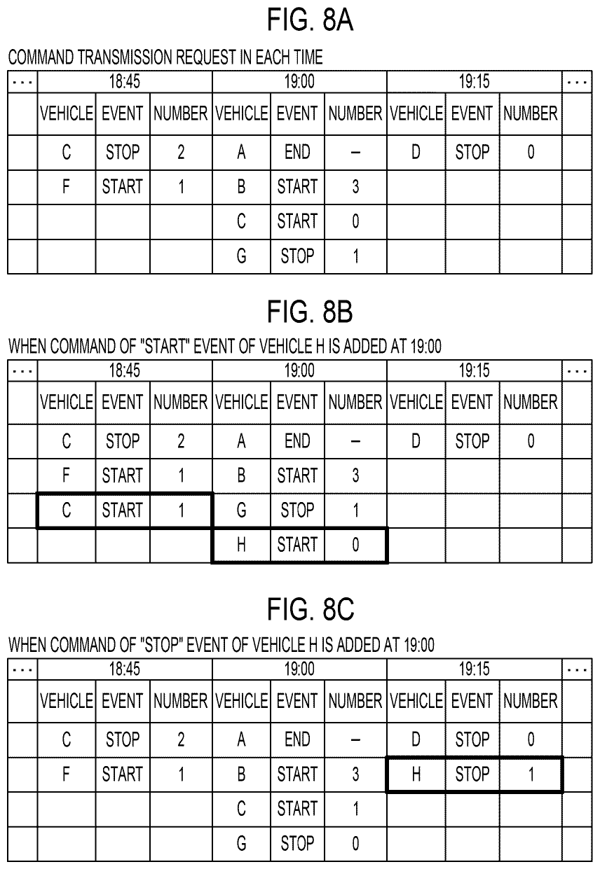

Processing executed by the processing circuit 51 will be described with reference to FIGS. 8A to 8C. In the example shown in FIGS. 8A to 8C, the upper-limit transmission number, which is the number of commands that can be transmitted such that the processing delay does not occur at the same time in the charge and discharge management system 100, is set to, for example, four.

FIG. 8A shows the transmission requests at each time, and commands to be transmitted at each time are scheduled for each of the battery electric vehicles A to I. In the example shown in FIG. 8A, at the time of 19:00, there is a command of the “end” event of the battery electric vehicle A, and a command of the “start” event of the battery electric vehicle B, and the adjustment number is three. At the time of 19:00, there is a command of the “start” event of the battery electric vehicle C and the adjustment number is 0, and a command of the “stop” event of the battery electric vehicle G and the adjustment number is 1. At the time of 19:00, the number of commands to be transmitted reaches four, which is the upper-limit transmission number. In this case, assuming that the command of the battery electric vehicle H is added at the time of 19:00, the transmission-command number is larger than the upper-limit transmission number (S120: NO). In a case where the situation is as described above, the processing circuit 51 compares the adjustment number of each of the commands as the priorities of each of the commands.

FIG. 8B shows a case where the command of the “start” event of the battery electric vehicle H is added. The processing circuit 51 determines that the adjustment number of the battery electric vehicle C is zero and the priority of the command is the lowest by comparing the adjustment number of each command at the time of 19:00. In this case, the processing circuit 51 determines that the priority of the command of the battery electric vehicle H is the same as the priority of the command of the battery electric vehicle C based on the adjustment number. The processing circuit 51 further determines that the priority of the command of the battery electric vehicle H is lower than the priority of the commands of the battery electric vehicle A, the battery electric vehicle B, and the battery electric vehicle G. In this case, the processing circuit 51 keeps transmitting the command of the battery electric vehicle A, the battery electric vehicle B, and the battery electric vehicle G at the scheduled time of 19:00. Further, the processing circuit 51 shifts any one of the command of the battery electric vehicle H and the command of the battery electric vehicle C from the time of 19:00. In the present embodiment, the processing circuit 51 determines which transmission time of which command is to be shifted in the content of the event for the command of the battery electric vehicle H and the command of the battery electric vehicle B. The content of the event of the command of the battery electric vehicle H to be newly added is the start, and the content of the event of the command of the battery electric vehicle C is also the start. Therefore, the “start” command of the battery electric vehicle C is adjusted to be shifted from the time of 19:00 to the time of 18:45, which is an earlier time than the time of 18:45. This is for giving priority to the charging of the battery electric vehicle C, of which the start of the charging is planned in advance, and starting the charging of the battery electric vehicle C in advance.

FIG. 8C shows a case where the command of the “stop” event of the battery electric vehicle H is added. The processing circuit 51 determines that the adjustment number of the battery electric vehicle G is zero and the priority of the command is the lowest by comparing the adjustment number of each command at the time of 19:00. In this case, the processing circuit 51 determines that the priority of the command of the battery electric vehicle H is the same as the priority of the command of the battery electric vehicle G based on the adjustment number. The processing circuit 51 further determines that the priority of the command of the battery electric vehicle H is lower than the priority of the commands of the battery electric vehicle A, the battery electric vehicle B, and the battery electric vehicle C. In this case, the processing circuit 51 keeps transmitting the command of the battery electric vehicles A, B, C at the scheduled time of 19:00. Further, the processing circuit 51 shifts any one of the command of the battery electric vehicle H and the command of the battery electric vehicle G from the time of 19:00. In the present embodiment, the processing circuit 51 determines which transmission time of which command is to be shifted in the content of the event for the command of the battery electric vehicle H and the command of the battery electric vehicle G. The content of the event of the command of the battery electric vehicle H to be newly added is stop, and the content of the event of the command of the battery electric vehicle G is also stop. Therefore, the command of the battery electric vehicle H to be newly added is adjusted to be shifted from the time of 19:00 to the later time of 19:15.

In addition, the storage device 52 further stores a predetermined value that is an upper limit value of the adjustment number. As shown in FIGS. 8A to 8C, there is a “start” event of the battery electric vehicle B at the time of 19:00 and a command with the adjustment number of three. For example, when the upper limit value of the adjustment number is three times, the upper limit value is set as follows. That is, the command for the “start” event of the battery electric vehicle B and the command having the adjustment number of three times are set to be transmitted at the time of 19:00 scheduled without adjusting the transmission time regardless of the content of the event. The predetermined value may be set in consideration of not causing the load or deterioration of the charge and discharge system due to excessive adjustment or an increase in the adjustment number. The predetermined value may be set to two times, or four times or more, in addition to three times.

### Operation of Third Embodiment

In the charge and discharge management system 100, the command priority information includes an adjustment number representing the number of times the transmission time of the command is adjusted based on the command priority information for each command. The more the adjustment number is, the higher the command priority is set. The command priority depending on the adjustment number is set such that, in a case where the adjustment number is equal to or greater than a predetermined value, the transmission time is not adjusted for the command for which the adjustment number is equal to or greater than the predetermined value.

The transmission time of the command having the low command priority is easily repeatedly adjusted. As a result, the charge and discharge process is significantly delayed, and the risk that the entire charging plan is delayed is increased. In addition, there is a possibility that the user cannot use the battery electric vehicle as planned and the reliability of the system is reduced.

The charge and discharge management system 100 manages the adjustment number as the command priority information, and sets the priority on the adjustment number such that the transmission time of the command is not adjusted when the adjustment number is equal to or greater than a predetermined value. As a result, the battery electric vehicle for which the adjustment is frequently performed is preferentially handled as compared with other battery electric vehicles, and the schedule of charging or discharging of the battery electric vehicle is preferentially set.

### Effect of Third Embodiment

The charge and discharge management system 100 can process an event, such as a stop, for which the command priority tends to be low with an appropriate priority according to the adjustment number. Therefore, it is possible to suppress excessive repetition of the adjustment and disorder of the schedule, and to improve the efficiency and reliability of the overall system.

### Modification

The first embodiment can be modified as follows to implement the third embodiment. The first embodiment to the third embodiment and modifications described below can be combined with each other and implemented in a range in which there is no technical contradiction.

In addition to the examples described in the first embodiment to the third embodiment, the time until the departure time set by the user may be included as the command priority information. In this case, the command priority is set to be higher as the time until the departure time is shorter, and may be set not to adjust the transmission time for the command when the time until the departure time does not satisfy the predetermined value, for example, three hours.

In the second embodiment, as shown in FIG. 7B, the content of the command is “start” for the battery electric vehicle B for which the determination is made that the command priority is low by using the needed charge amount. Therefore, the command of the battery electric vehicle B is adjusted to be shifted to the earlier time. Alternatively, as shown in FIG. 7C, the content of the command is “stop” for the battery electric vehicle H for which the determination is made that the command priority is low by using the needed charge amount. Therefore, the command of the battery electric vehicle H is adjusted to be shifted to the later time. However, the command of the battery electric vehicle B shown in FIG. 7B may be shifted to a later time. The command of the battery electric vehicle H shown in FIG. 7C may be shifted to the earlier time. The number of commands scheduled to be transmitted at the time of 19:00 may be four or less.

In the third embodiment, as shown in FIG. 8B, the content of the command is “start” for the battery electric vehicle C determined to have the low command priority by using the adjustment number. Therefore, the command of the battery electric vehicle C is adjusted to be shifted to the earlier time. Alternatively, as shown in FIG. 8C, the content of the command is “stop” for the battery electric vehicle H determined to have the low command priority by using the adjustment number. Therefore, the command of the battery electric vehicle H is adjusted to be shifted to the later time. However, the command of the battery electric vehicle C shown in FIG. 8B may be shifted to a later time. The command of the battery electric vehicle H shown in FIG. 8C may be shifted to the earlier time. The number of commands scheduled to be transmitted at the time of 19:00 may be four or less.

What is claimed is:

1. A charge and discharge management system configured to transmit commands to each of multiple battery electric vehicles to charge and discharge the multiple battery electric vehicles in response to the commands received by each of the multiple battery electric vehicles, the charge and discharge management system comprising:
a processing circuit; and
a storage device, wherein
the processing circuit is configured to execute
comparing a transmission-command number that is the number of commands scheduled to be transmitted to the multiple battery electric vehicles at each time based on a plan generated for each of the multiple battery electric vehicles with an upper-limit transmission number that is the number of commands transmittable at the same time without causing a processing delay, and determining whether the transmission-command number is equal to or less than the upper-limit transmission number,
when the transmission-command number is determined to be equal to or less than the upper-limit transmission number, maintaining a transmission time according to the plan, and when the transmission-command number is determined to be larger than the upper-limit transmission number, adjusting the transmission time of a command having a low command priority such that, the transmission time of the command having the low command priority is shifted to an earlier time or a later time than a time scheduled in the plan by using command priority information stored in the storage device in advance, and
transmitting the commands corresponding to each of the multiple battery electric vehicles according to the plan that has been adjusted.

2. The charge and discharge management system according to claim 1, wherein:
the command priority information includes contents of events to be executed on the multiple battery electric vehicles by the commands;
the contents of the events include an end indicating that charging or discharging is ended, a start indicating that charging or discharging is started, and a stop indicating that control of charging and discharging is temporarily stopped during charging or discharging; and
command priority regarding the contents of the events is set to decrease in an order of the end, the start, and the stop.

3. The charge and discharge management system according to claim 2, wherein:
the command priority information includes a needed charge amount that is needed to reach a target charge state set for each of the multiple battery electric vehicles; and
the command priority is set to be higher in the needed charge amount than in the contents of the events and is set to be higher as the needed charge amount is lower.

4. The charge and discharge management system according to claim 3, wherein:
in the adjusting the transmission time between commands for battery electric vehicles, among the multiple battery electric vehicles, having the needed charge amount of the same level, determination is made on which transmission time of the command is to be shifted based on the content of the event; and
when the content of the event of the command to be shifted is the start, the transmission time of the command is adjusted such that the transmission time is shifted to an earlier time than the time scheduled in the plan, and when the content of the event of the command to be shifted is the stop, the transmission time of the command is adjusted such that the transmission time is shifted to a later time than the time scheduled in the plan.

5. The charge and discharge management system according to claim 1, wherein:
the command priority information includes an adjustment number representing the number of adjustments made for the transmission time of each of the commands based on the command priority information;
command priority is set to be higher as the adjustment number is larger; and
the command priority regarding the adjustment number is set such that, when the adjustment number is equal to or larger than a predetermined value, the transmission time of a command for which the adjustment number is equal to or larger than the predetermined value is not adjusted.
